(19) United States
(12) Patent Application Publication
(10) Pub. No.: US 2014/0147550 A1
(43) Pub. Date: May 29, 2014

(54) UTILIZATION OF AN ENZYMATIC COMPLEX IN FARM ANIMALS FEED

(71) Applicants: Dominique HOOREMAN, Bellegarde (FR); Hervé HOOREMAN, Montmorency (FR); Jean-Noël HOOREMAN, Paris (FR); Denis HOOREMAN, Crepy en Valois (FR)

(72) Inventor: Dominique HOOREMAN, Bellegarde (FR)

(21) Appl. No.: 14/091,031

(22) Filed: Nov. 26, 2013

(30) Foreign Application Priority Data
Nov. 26, 2012 (FR) 12.03171

(51) Int. Cl. A23K 1/165

(52) U.S. Cl. CPC A23K 1/1653
USPC 426/7; 426/63; 435/220

(57) ABSTRACT

The invention relates to a method of supplementing farm animal feed with an enzymatic complex including a mixture of proteases, obtained by culturing a Streptomyces fradiae strain, wherein among this mixture of proteases one of them has an isoelectric point of around 7.0 and another has an isoelectric point of around 8.0. The invention also relates to feed compositions for farm animals including the enzymatic complex as well as the manufacturing process enzymatic complex thereof.

This application claims the benefit of French Patent Application No. 12.03171, filed on Nov. 26, 2012, which is hereby incorporated herein by reference in its entirety.

### BACKGROUND OF THE INVENTION

1. Field of the Invention

The technical field of the present invention is that of animal nutrition. 2. Description of the Related Art

It is known that the Streptomyces fradiae strain is able to produce at least five types of protease known by Ia, Ib, II, III, IV and two peptidases (patent GB-1133579).

In their patent application WO 87/07905, the applicants described a process to obtain a proteolytic complex composed exclusively of type II, III and IV proteases with a predominance of type II protease. This complex is obtained from a Streptomyces fradiae WAKSMAN 3535 strain by fermentation, extraction of the complex by filtration, then ultrafiltration on a membrane having a cut-off level corresponding to a molecular weight of between 2,000 and 12,000, and finally by atomization. The complex thus obtained in powder form has a titer of at least 2,000 Anson units/mg of protein.

In this application, the type II protease was characterized by a molecular weight approaching 18 kDa and an isoelectric point approaching 9.0.

This complex, used in animal foodstuffs, enables the animals to easily assimilate feed with high crude protein content thereby promoting their growth. Additionally, this complex, used for gestating sows, promotes increased birth weights as well as a reduction in food consumption and an overall improvement in health.

However, this process is not able to effectively eliminate further contaminating by-products.

In patent application WO 97/37681, improvements are made enabling the use of a product with a titer of at least 4,000 Anson units/mg of protein for therapeutic applications. Thus, the predominant proteinase has a specific activity of over 100,000 Anson units/mg of protein with a molecular weight of between 30 and 36 kDa and an isoelectric point approaching 7.0.

Subsequent analyses showed that the molecular weight of the protease was of 18-20 kDa.

The therapeutic applications described essentially consist of a positive action in the reduction of the secretion of mucus characteristic of certain illnesses, in an improvement in intestinal absorption and blood flow or else in the fight against infectious diseases. Additionally, the compositions are described as able to facilitate the regeneration of atrophied or damaged villi in the intestinal lining.

In view of the considerable therapeutic properties of the enzymatic complex extracted from Streptomyces fradiae cultures, it is important to use an enzymatic complex more completely cleared of biological impurities that might hinder its activity.

### SUMMARY OF THE INVENTION

The aim of the present invention is thus to improve the previously described enzymatic complex namely in order to enhance breeding conditions and animal health in factory farms.

The invention thus relates to the utilization of an enzymatic complex comprising a mixture of proteases obtained by culturing a Streptomyces fradiae strain to supplement farm animals feed, characterized in that among this mixture of proteases one of them has an isoelectric point of around 7.0 and another has an isoelectric point of around 8.0.

Said complex predominantly contains these two types of proteases, in other words a proportion of these two proteases exceeding 80% of the activity of said mixture.

According to one characteristic of the invention, the protease whose isoelectric point is of around 7.0 has a specific activity of around 150,000 Anson units/mg of protein.

According to one characteristic of the invention, the protease whose isoelectric point is of around 8.0 has a specific activity of around 38,000 Anson units/mg of protein.

According to another characteristic of the invention, the enzymatic complex is used as a feed supplement in powder, liquid or any other form suited to its mixture with feed compositions to improve the general condition of factory farm animals.

According to another characteristic of the invention, the enzymatic complex in powder form is dry mixed with a feed composition in a rotating drum until homogenized.

According to another characteristic of the invention, the enzymatic complex in liquid form is pulverized in a fluidized bed onto a feed composition, and is then granulated.

According to another characteristic of the invention, the enzymatic complex is used in poultry feed.

According to another characteristic of the invention, the enzymatic complex is used in pig feed.

According to another characteristic of the invention, the enzymatic complex is used in fish feed.

The invention also relates to a feed composition for farm animals comprising the enzymatic complex according to the invention and possibly including excipients or vehicles for nutriments, or other additives.

The invention lastly relates to a manufacturing process for the enzymatic complex according to the invention, characterized in that a Streptomyces fradiae strain is cultured, in that the fermentation broth is filtered, in that the enzymatic complex is thereafter extracted by ultrafiltration and ion exchange chromatography followed by an isoelectric focusing and finally, the complex thus obtained is lyophilized.

This invention provides a feed supplement whose characteristics are strictly defined.

The invention firstly enables to adapt precisely the doses to be administered into the feed compositions so as to obtain the required therapeutic effects.

The invention also has the advantage of improving the health of animals in the factory farms.

In addition, the invention also brings an improvement to the general condition of the animals in the factory farms enhancing the profitability of such facilities.

The invention further enables an improved animal growth combined with a reduction in food consumption.

Other characteristics, particulars and advantages of the invention will become more apparent from the additional description given hereafter of different embodiments given by way of example and with respect to the figures illustrating intestinal villi.

### DETAILED DESCRIPTION OF PREFERRED EMBODIMENTS

It is known that the enzyme mixture commercialized under the trademark Panstimase® (PANcreatic STIMulating diastASE) is an enzymatic complex obtained by fermentation of Streptomyces fradiae. This complex is described as essentially containing three proteases, certain of which specifically act on sclerotial proteins (collagen, elastin, and keratin), but also on certain toxins of proteic nature released by choleraic vibrio or certain pathogenic Escherichia coli strains.

In the domain of animal husbandry, it is important to have a product that is technically defined, perfectly constant and whose properties are thus clearly defined.

So as to obtain the enzymatic complex according to the invention a Streptomyces fradiae strain is cultured and the resulting fermentation broth is filtered. Thereafter, the enzymatic complex is extracted and characterized by ultra-filtration, ion exchange chromatography and isoelectric focusing. Lastly, the resulting complex is lyophilized.

For the Streptomyces fradiae culture, a strain of the type WAKSMAN 353 for example is used, able to be genetically improved to namely obtain an increase in the proteolytic activity or the suppression of any secretion of antibiotics.

The culture takes place in a large scale fermenter in a suitable growing medium. This growing medium may, for example, be based on soybean meal: 15 g/l; glucose: 30 g/l; bipotassic phosphate: 1 g/l; calcium carbonate: 10 g/l.

The reaction takes place at a pH of between 7.0 and 7.5, at a fermentation temperature of around 28° C. with an aeration of 0.3 volumes of sterile air for one volume of medium per minute.

Once is culture is completed, the mycelium is eliminated by filtration of the fermentation broth using a clarifying agent.

The extraction of the enzymatic complex required the implementation of several techniques including ultra-filtration, ion exchange chromatography and isoelectric focusing.

### Ultra-Filtration

The ultra-filtration of the filtrate is performed using a membrane with a cut-off level of 50 kDa.

After 3 h of filtering, the filtrate (71% of the initial volume) has a proteolytic activity revealed by the gelatin film assay. This assay consists in deteriorating a film of silver gelatin arranged on a solid frame.

### Ion Exchange Chromatography Assay

A cation exchange chromatography is used made with columns of Cellufine C-500 carboxymethyl gel (Amicon) of suitable dimensions.

The chromatographic buffer is a citrate buffer 10 mM at pH 5.5 and the elution is performed by a NaCl gradient of 0 to 1.0 M. The elution rate depends on the size of the columns, for example, it is of 10 to 15 ml/min for a column of 2.5 cm in diameter and 27 cm in height.

### Isoelectric Focusing

Analytical isoelectric focusing is performed using ready-to-use gels made by Pharmacia for pHs from 3 to 9 on Phast-system. Revelation is performed using Coomassie blue.

In the case of preparative isoelectric focusing in a solid medium, the enzyme solution is dialyzed against distilled water (95 ml) and mixed with 5 ml of 3-9 ampholytes with 4.7 g of Ultrodex gel and 0.5 g of glycine. The gel is dried for 6 h at 40° C. Migration takes place during the night, or equivalent period, at a constant power of 3 W. Revelation is performed using Coomassie blue.

The different gel strips are taken, rinsed with 3 ml of water, filtered, and then rinsed with 3 ml of Tris-HCI buffer.

The fractions thus obtained are then analyzed to determine their proteolytic activity and protein content. The samples are then dialyzed against the Tris-HCI buffer 0.3 M pH 8.0.

In the case of preparative isoelectric focusing in a liquid medium, the enzyme solution dialyzed against distilled water is mixed with the ampholytes (3.5 ml). Migration is performed at a constant power of 8 W during 4 h.

The fraction samples are analyzed then dialyzed against the Tris-HCI buffer 0.3 M pH 8.0.

The experimental conditions indicated above are to be adapted according to the quantities of product required to be obtained and to its utilization in industrial conditions.

A predominant protease is thereby obtained in the mixture that has an isoelectric point (IEP) of around 7.0 and in a lesser proportion a protease whose IEP is of around 8.0.

The predominant protease whose IEP is of around 7.0 is obtained in a volume of 9 ml with a protein concentration of 0.49 mg/ml. Special precautions for purification may be required because of the precipitation of this protease at its isoelectric point. The solution obtained has a titer of around 75,000 Anson units (A.U)/ml.

This protease is purified after homogenization at a scale of 4 mg with a specific activity of 150,000 A.U/mg of protein.

One Anson unit (AU) is defined here as being the quantity of enzyme which, incubated for 10 minutes at 25° C. and at pH 7.5 in the presence of denatured hemoglobin, releases from this substrate the equivalent of 1 microgram of tyrosine, determined by spectrophotometric absorption at 280 nm on the filtrate that cannot be precipitated with trichloracetic acid.

The protease, whose IEP is of around 8.0, is recovered jointly with the previous one but in a greater volume, of 35 ml for example, and has a protein concentration of 1.48 mg/ml. This solution has a titer of around 56,000 A.U/ml.

This protease is purified after homogenization at a scale of 50 mg with a specific activity of around 38,000 A.U/mg of protein.

The previously described enzymatic complex essentially contains proteases and other proteins. The purifications performed and the electrophoresis technique used prove an additional purification and the elimination of contaminating materials that have no proteolytic activity.

The different proteases produced may be better characterized by determining that activities on proteins such as collagen, keratin, elastin or hemoglobin.

Unfortunately, these determinations are complicated because of their lack of sensitivity and specificity. Recourse must therefore be made to several activity assays, constituting detection methods, and principally the Anson method.

### Activity Assays

### Anson Assay

This assay enables a proteolytic activity to be dosed, without specificity. It consists in dosing the hydrolysis of the denatured hemoglobin by spectrophotometric determination of the tyrosine contained in the oligopeptides released.

### Azocasein Assay

This assay consists in determining by spectrophotometry at 440 nm the hydrolysis of the casein stained by an orange dye. This assay is not specific. After incubation with the enzyme, the remaining azocasein is precipitated using trichloroacetic acid. Measuring the optical density reflects the presence of the peptides released, and thus the enzymatic activity.

### Elastolytic Activity Assay

### Elastin Congo-Red Assay

This assay consists in spectrophotometrically dosing at 495 nm the stained peptides released by the hydrolysis of the elastin stained by a red dye.

A possible problem of this dosage lies in the insolubility of the substrate and thus its sensitivity depends on the sample accuracy, the stirring of the incubation medium and the adherence of the substrate to the walls of the incubation vessel.

The assays performed show a lack of linearity between the activity and quantity of enzyme. There is effectively linearity between the activity and the incubation time, but the straight line representing it does not pass through the origin.

A difference in absorbance can thus be measured between the incubation times (20 and 40 minutes). With 10 μl of complex diluted 10 times, a variation of 0.049 μDO/min is measured. The enzymatic complex according to the invention thus does have a proteolytic activity with respect to the elastin.

### NBA Assay

### N-Bloc-L-Alaninate-para-nitrophenyl ester

This assay consists in spectrophotometrically dosing at 347.5 nm the esterase activity present in the elastase by determining the para-nitrophenol released (Vissier L. et al. Biochim, Biophys Acta 268 (1972) 207.260).

This dosage is not specific to an elastolytic activity, but is very fast (kinetics of 3 min) and has good sensitivity.

Indeed, with 50 μl of complex diluted 100 times, a variation of 0.235 μDO/min is measured. The enzymatic complex thus does have an activity enabling the release of para-nitrophenol.

### Collagenolytic Activity Assay

### Azocoll Assay

This assay consists in spectrophotometrically dosing at 520 nm the peptides released by the hydrolysis of the azocoll (ground collagen stained with a Bordeaux red dye) (Chavira, Analytical Biochemistry 136 (1984) 446-450).

This assay suffers from the same drawbacks as that of elastin Congo-Red (insoluble substrate), but has good sensitivity: with 50 μl of complex diluted 50 times, a DO of 0.398 is measured after incubation during 10 minutes. The enzymatic complex according to the invention thus does have a proteolytic activity with respect to the azocoll.

The proteolytic activity of the enzymatic complex according to the invention is thus established. The purification of said complex has not altered its activity.

The protein complex thus obtained and characterized can be used in animal therapeutics, namely by way of an immunostimulant agent and as a regeneration agent for the Peyer's Patches, in particular for older animals.

Additionally, the enzymatic complex enables the regeneration of intestinal villi in older animals (rats, chickens, etc) and thus greatly improves the intestinal absorption of essential nutriments.

The enzymatic complex according to the present invention is mainly intended for animal husbandry and more particularly for the improvement of cattle feed (bovine, porcine, ovine) and poultry, rabbit and fish feed as well as feed for any other monogastric animal.

Incorporated at doses from 0.025 to 1 g/kg to feed compositions, this enzymatic complex enhances the metabolism of these animals and contributes towards ensuring better general health. Preferably, the doses of the complex introduced into the feed compositions are of 0.05 to 0.2 g/kg.

In the case of battery farming, maintaining good general health is important as this avoids the propagation of illnesses caused by promiscuity or confinement. The morbidity rate is thus substantially reduced and notably the mortality rate by bacterial contamination of farm animals.

The feed compositions based on this enzyme mixture contain one or several excipients or vehicles for nutriments, such as for example, grain flour (wheat, maize, rye, rice, millet, and sorghum), soybean, carbohydrates (lactose, mannose), loading elements (casein, bran, cellulose, cellulose derivatives) and/or mineral elements (chalk, clay, bentonite, silica) and all other elements used in animal nutrition.

These compositions are thoroughly dry mixed with the complex in a rotating drum, or the enzymatic complex, in a liquid and particularly aqueous form, is sprayed as a fluidized bed on a feed composition and then granulated. Such operations may be performed at variable temperatures from 15° C. to 60° C.

The use of an enzymatic complex that is purer and more active thereby enables the biological activity of the nutritive compositions according to the invention to be better dosed and a satisfactory homogenization of the results to be obtained.

For this reason, feed compositions according to the invention have an enzymatic complex content that is clearly determined and constant.

Thus, here is a non-exhaustive list of examples of feed compositions intended for farm animals that contain the enzymatic complex according to the invention mixed with excipients or appropriate vehicles of nutrition.

### Poultry Feed Composition

A composition is prepared for a batch of 10 kg adding the enzymatic complex:

| | | |
|---|---|---|
| Wheat flour | 2.5 | kg |
| Lactose | 4.5 | kg |
| Bran | 3 | kg |
| Enzymatic complex according the invention | 0.2 | g/kg. |

Such a composition is incorporated at a proportion of 0.5 kg per metric ton of poultry feed.

### Poultry Feed Composition

A composition is prepared for a batch of 20.1 kg to which the enzymatic complex is added and which is then incorporated into the poultry feed:

| | | |
|---|---|---|
| Wheat flour | 1.5 | kg |
| Oat flour | 4.5 | kg |
| Cellulose | 14 | kg |
| Colloidal silica | 0.100 | kg |
| Enzymatic complex according the invention | 0.1 | g/kg. |

### Pig Feed Composition

A composition is prepared for a batch of 10 kg to which the enzymatic complex is added and which is then incorporated into the pig feed:

| | | |
|---|---|---|
| Wheat flour | 4 | kg |
| Bran | 2 | kg |
| Casein | 3 | kg |
| Potato starch | 1 | kg |
| Enzymatic complex according the invention | 0.2 | g/kg |

### Cattle Feed Composition

A composition is prepared in the same way using:

| | |
|---|---|
| Rice starch | 0.5 kg |
| Potato starch | 2.5 kg |
| Enzymatic complex according the invention | 0.2 g/kg. |

The premix thus formed is added little by little to a mixture of 6 kg of mutton protein powder and 14 kg of casein. The homogenized preparation is intended to be incorporated into the cattle feed in a proportion of 0.5 kg per metric ton of feed.

### Poultry Feed Composition

The composition is prepared for a batch of 10 kg to which the enzymatic complex is added:

| | | |
|---|---|---|
| Maize | 5.65 | kg |
| Soybean meal | 3.23 | kg |
| Cottonseed meal | 0.3 | kg |
| Wheat germ flour | 0.4 | kg |
| Chalk | 0.13 | kg |
| Di-calcium phosphate | 0.16 | kg |
| NaCl | 0.03 | kg |
| Amino acid complex | 0.1 | kg |
| Enzymatic complex according the invention | 0.2 | g/kg. |

The enzymatic complex according to the invention may also be added to off-the-shelf poultry feed compositions so as to supplement these preparations.

### Fish Feed Composition

The following composition is prepared and incorporated into the fish feed following the customary practice.

| | |
|---|---|
| Fish meal | 50.8% |
| Animals fats and oils | 28% |
| Soybean meal | 9.9% |
| Wheat flour | 10% |
| Vitamin complex | 1% |
| (A, D, E, C, . . . ) | |
| Enzymatic complex according the invention. | 0.3% |

### Experimental Part

To determine the action of the complex according to the invention on intestinal villi, assays are performed on relatively old rats (more than seven months old).

These rats are given food based on vegetal proteins exclusively of the type wheat flour, soybean, or maize. The enzymatic complex according to the invention as described previously is added to this feed in the proportion of 0.1 or 0.2 g/kg.

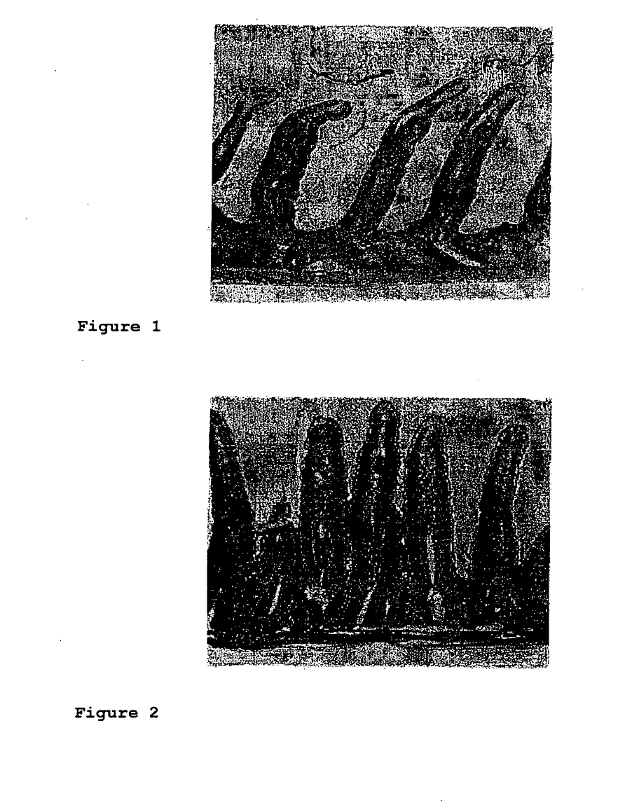

The results are explained in FIGS. 1 to 4. These figures are photonic microscopic views (enlargement ×120) of the villi of the duodenum and jejunum.

FIG. 1 shows the duodenal villi of rats not having received the enzymatic complex according to the invention in their feed.

FIG. 2 shows the duodenal villi of rats having received feed incorporating the enzymatic complex according to the invention.

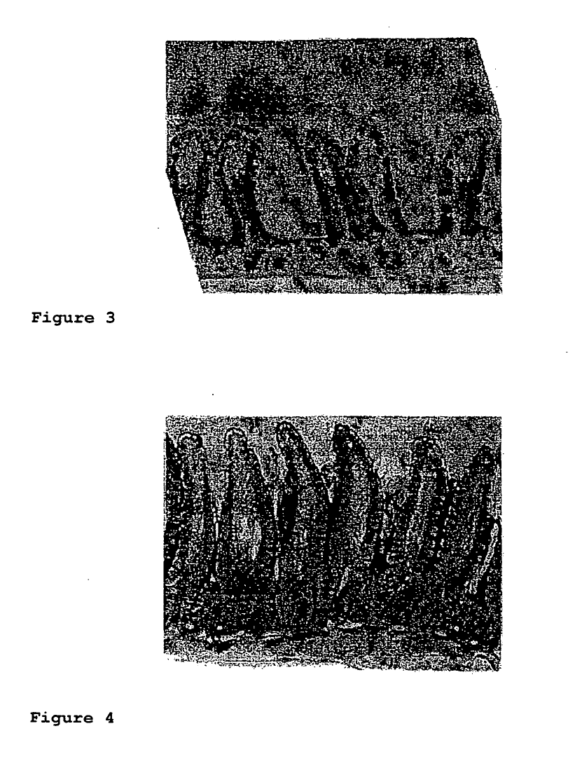

FIG. 3 shows the jejunal villi of rats not having received the enzymatic complex according to the invention in their feed.

FIG. 4 shows the jejunal villi of rats having received feed incorporating the enzymatic complex according to the invention.

This establishes that the addition of the enzymatic complex in the feed of older animals (rats, chicken, etc.) increases the size and number of the villi in both the duodenum and the jejunum. Increases of up to 70% have been observed.

These results are transferable to intestinal microvilli. Similar results are obtained with chickens, pigs and fish.

An increase in the surface area enables faster absorption of nutriments or medicines.

This improved absorption is observed in trouts receiving feed containing an antibiotic. In the assay, the feed contains 4 g/kg of oxytetracycline and the results are read after 48 hours. An increase in the tissue concentration of the antibiotic is thus observed of a magnitude of 100% in the liver (5.75 instead of 2.5 microgram/g), 400% in the muscles (1.75 instead of 0.32 microgram/g) and 1000% in the kidneys (5.75 instead of 0.5 microgram/g).

Similar results are obtained with chicken and pigs.

This increase in density may lead to an increase in the local production of physiologically active compounds such as intestinal hormones.

1. A method of supplementing farm animal feed, comprising adding an enzymatic complex comprising a mixture of proteases obtained by culturing a Streptomyces fradiae strain to farm animal feed, wherein among this mixture of proteases one of them has an isoelectric point of around 7.0 and another has an isoelectric point of around 8.0.

2. The method according to claim 1, wherein the protease whose isoelectric point is of around 7.0 has a specific activity of around 150,000 Anson units/mg of protein.

3. The method according to claim 1, wherein the protease whose isoelectric point is of around 8.0 has a specific activity of around 38,000 Anson units/mg of protein.

4. The method according to claim 1, wherein the enzymatic complex is in powder, liquid or any other form suited to its mixture with the farm animal feed to improve the general condition of factory farm animals.

5. The method according to claim 4, wherein the enzymatic complex in powder form is dry mixed with the farm animal feed in a rotating drum until homogenized.

6. The method according to claim 4, wherein the enzymatic complex in liquid form is pulverized in a fluidized bed onto the farm animal feed, and is then granulated.

7. The method according to claim 1, wherein the farm animal feed is a poultry feed.

8. The method according to claim 1, wherein the farm animal feed is a pig feed.

9. The method according to claim 1, wherein the farm animal feed is a fish feed.

10. Feed composition for farm animals comprising:
an enzymatic complex comprising a mixture of proteases obtained by culturing a Streptomyces fradiae strain, wherein among this mixture of proteases one of them has an isoelectric point of around 7.0 and another has an isoelectric point of around 8.0, and
optionally including excipients or vehicles for nutriments.

11. Manufacturing process for an enzymatic complex comprising a mixture of proteases obtained by culturing a Streptomyces fradiae strain, wherein among this mixture of proteases one of them has an isoelectric point of around 7.0 and another has an isoelectric point of around 8.0, comprising:
Culturing a Streptomyces fradiae strain,
filtering the fermentation broth,
thereafter extracting the enzymatic complex by ultrafiltration and ion exchange chromatography followed by an isoelectric focusing, and
finally, lyophilizing the complex thus obtained.
